(19) United States
(12) Patent Application Publication
(10) Pub. No.: US 2006/0262758 A1
(43) Pub. Date: Nov. 23, 2006

(54) Distributed communications for wireless networks

(76) Inventors: Sumeet Sandhu, San Jose, CA (US); Boyd R. Bangerter, Portland, OR (US)

Correspondence Address: INTEL CORPORATION, P.O. BOX 5326, SANTA CLARA, CA, 95056-5326, US

(21) Appl. No.: 11/131,560

(22) Filed: May 17, 2005

(51) Int. Cl. H04Q 7/24

(52) U.S. Cl. 370/338

(57) ABSTRACT

Methods and devices for wireless networks for extending the communications range of an originating device without increasing its transmit power or bandwidth. An originating device may include signaling in a physical (PHY) layer packet such that peer network devices may know to retransmit the received packet substantially in synchronization with one another. The subsequent and substantially simultaneous transmission of the original signal by peer network devices may effectively increase the range of the originating device so a transmission may reach its destination. Various embodiments and implementations are also disclosed.

### BACKGROUND OF THE INVENTION

One limitation of wireless networks may be the range of the respective wireless device. For example, the effective range of a wireless device is typically limited by the maximum transmit power allowed for that device. Accordingly, peer devices outside the maximum range of a wireless device may not receive transmissions targeted for the peer devices.

Increasing the maximum transmit power for a given device may not always be an option for extending range since the transmit power of a given device may be restricted by various standards, regulations and/or for safety reasons.

It may thus be desirable to be able to increase the transmit range of a wireless device without increasing its maximum transmit power.

### BRIEF DESCRIPTION OF THE DRAWING

Aspects, features and advantages of embodiments of the present invention will become apparent from the following description of the invention in reference to the appended drawing in which like numerals denote like elements and in which:

FIG. 1 is block diagram of a wireless network according to one example implementation for various embodiments of the present invention;

FIG. 2 is a flow chart showing a process of extending range using cooperative diversity according to one embodiment of the present invention; and

FIG. 3 is a block diagram showing an example wireless apparatus according to various aspects of the invention.

### DETAILED DESCRIPTION OF THE INVENTION

While the following detailed description may describe example embodiments of the present invention in relation to wireless networks utilizing Orthogonal Frequency Division Multiplexing (OFDM) modulation, the embodiments of present invention are not limited thereto and, for example, can be implemented using other modulation and/or coding schemes where suitably applicable. Further, while example embodiments are described herein in relation to wireless personal area networks (WPANs), the invention is not limited thereto and can be applied to other types of wireless networks where similar advantages may be obtained. Such networks for which inventive embodiments may be applicable specifically include, wireless local area networks (WLANs), wireless metropolitan area networks (WMANs), and/or wireless wide area networks (WWANs) such as cellular networks and the like.

The following inventive embodiments may be used in a variety of applications including transmitters and receivers of a radio system, although the present invention is not limited in this respect. Radio systems specifically included within the scope of the present invention include, but are not limited to, network interface cards (NICs), network adaptors, mobile stations, base stations, access points (APs), gateways, bridges, hubs and routers. Further, the radio systems within the scope of the invention may include cellular radiotelephone systems, satellite systems, personal communication systems (PCS), two-way radio systems and two-way pagers as well as computing devices including radio systems such as personal computers (PCs) and related peripherals, personal digital assistants (PDAs), personal computing accessories and all existing and future arising systems which may be related in nature and to which the principles of the inventive embodiments could be suitably applied. Other communication systems to which the principles of the inventive embodiments include sensor technologies such as radio frequency identification (RFID) tags and the like.

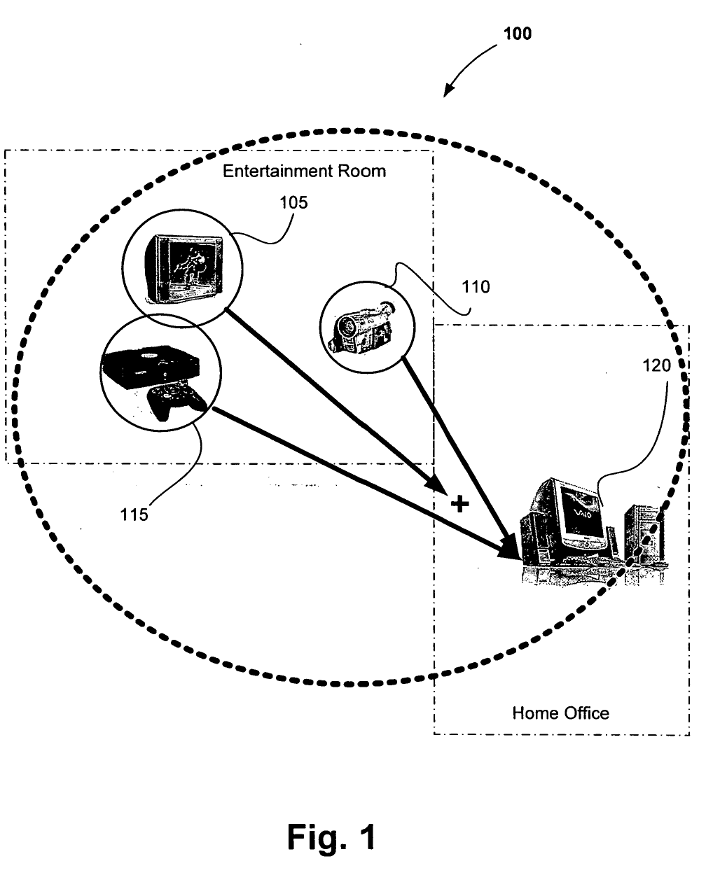

Turning to FIG. 1, a wireless communication network 100 according to various inventive embodiments may be any system having devices capable of transmitting and/or receiving information via over-the-air (OTA) radio frequency (RF) links. For example in one embodiment, network 100 may be a wireless network such as an ultra-wideband (UWB) network or wireless network compatible with the Institute of Electrical and Electronics Engineers (IEEE) various 802 wireless standards including for example, 802.11(a), (b), (g) and/or (n) standards for WLANs, 802.15 standards for WPANs, and/or 802.16 standards for WMANs, although the inventive embodiments are not limited in this respect.

In one embodiment, network 100 may include a plurality of electronic devices 105, 110, 115, 120 each including a receiver, transmitter or transceiver for transmitting and/or receiving information over one or more wireless channels.

In a conventional point-to-point configuration, an originating device (e.g., television 105) might transmit information, for example a video stream, intended for a specific receiving device (e.g., computer 120). However, if television 105 is equipped with a WPAN device such as an ultra-wideband (UWB) transmitter, its range might likely be limited to a room in which television 105 is located. Accordingly, if computer 120 is located in a different room, the transmit range of the UWB transmitter in television 105 might be too short to effectively communicate wirelessly with computer 120.

However, with the cooperative diversity techniques of the inventive embodiments, neighboring peer devices (e.g., camcorder 110 and/or game system 115) may be adapted to cooperatively transmit the information from television 105 to effectively extend the transmit range of television 105.

In one example embodiment, television 105 may first transmit information to peer devices 110, 115 which may capture the transmission and/or save it. It should be realized that computer 120 may likely be the originating device and television 105 or other device may be the destination device. Consequently, the discussion herein is but one non-limiting example of how such a network may function. In a subsequent transmit opportunity; multiple network devices (e.g., 110, 115, 105) may transmit the same information at substantially the same time. If the transmission from different devices 110, 115 and/or 105 is weighted and synchronized, it may add coherently to extent the transmit range and reach computer 120 in tact. The substantially simultaneous transmission of signals carrying the same, or substantially the same, data by more than one electronic device in referred to herein as “cooperative transmission” or “cooperative diversity transmission.”

The concept of cooperative transmission can be compared to antenna systems in which multiple transmit antennas transmit to a single or multiple receive antennas, also respectively called multiple input single output (MISO) or multiple input multiple output (MIMO) systems. However, there are significant differences between multi antenna systems and cooperative diversity devices as described herein. For example, in MISO systems the transmit power is typically normalized to be the same as a single transmit antenna on a single device. Additionally, there are multiple transmit antennas on each MISO or MIMO device and these are typically synchronized in terms of sample time and carrier phase.

In the various embodiments of wireless network 100 however, there is no need for power normalization between various peer devices (e.g., 110, 115), thus for example, a higher range gain may be achieved as compared to MISO systems. For example, with open-loop diversity mode transmission (e.g., using Alamouti code), the gain from just two devices utilizing cooperative diversity may be as high as 6 dB. In essence, this may double the range in free space and with more cooperating devices; the range can be significantly increased even in an indoor environment having significant path loss.

Another technology having aspects comparable to the inventive embodiments herein is known as mesh networking. In mesh networking, nodes of a network may be adapted to relay packets from an originator over one or more hops, usually in an ad-hoc fashion, to reach a destination. Mesh networking may have overhead for network synchronization and time delays for packet retransmission similar to the cooperative diversity embodiments disclosed herein; however, conventional mesh networks do not coherently add simultaneous transmissions of multiple devices to increase range of transmissions. To that end, the inventive embodiments discussed herein may be implemented within a mesh networking infrastructure to enhance mesh transmission ranges where suitably desired.

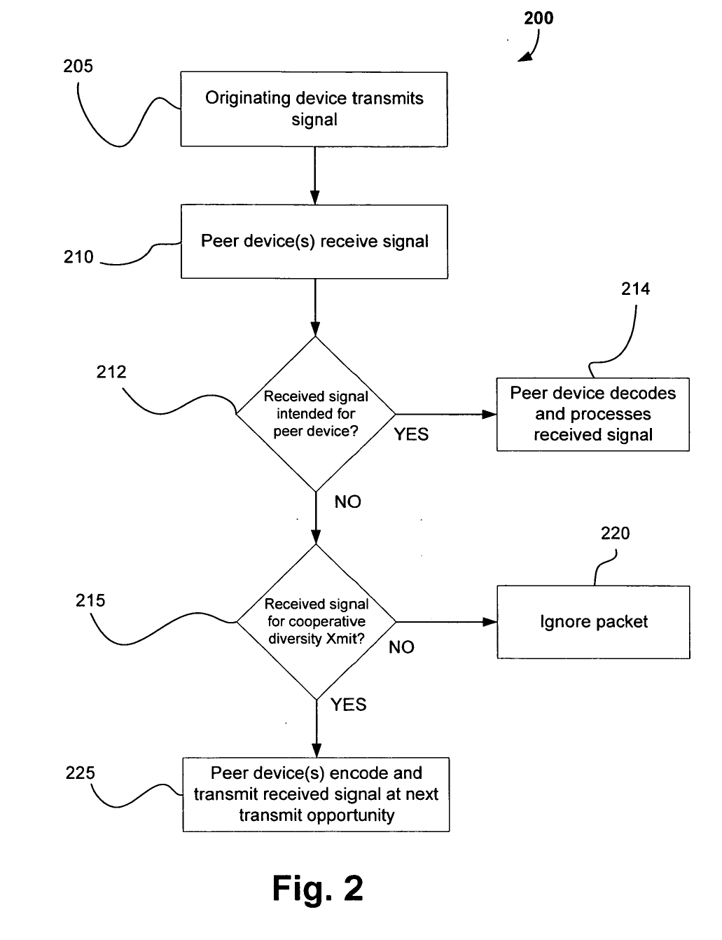

Turning to FIG. 2 a method 200 for communicating in a wireless network using cooperative diversity may generally include receiving 210 a signal at a first device (e.g., 110, 115; FIG. 1) from a second device (e.g., 105; FIG. 1), determining 212 if the received signal is intended for the receiving device and if not, determining 215 that the signal is for cooperative transmission and re-transmitting 225 the transmit signal.

While cooperative diversity by peer devices could ultimately be utilized for every transmission in a wireless network, it may alternatively only be used or desired in the case where the originating device does not have an established communication link with the destination device; for example, where the maximum transmit range of the originating device is insufficient to successfully deliver a data signal to the destination. In any event, where cooperative transmission by peer network devices is desired, the originating device may encode or signal that its transmission is intended for cooperative transmission by other devices.

In one embodiment, encoding or signaling that the transmission from the originating device is for cooperative diversity transmission by other devices may be done entirely in the physical (PHY) layer, although the inventive embodiments are not limited in this respect. In this manner, packet overhead may be saved and/or higher layer signal processing by peer devices merely intended to retransmit a signal may be reduced or avoided entirely.

When the originating device (e.g., 105; FIG. 1) transmits 205 a signal, any peer devices within the transmit range of the originating device, and which are adapted to perform cooperative transmission, may receive 210 the signal and process the received signal to determine 212 if they are the destination device. If the peer device determines 212 it is the destination device, it may decode and/or process 214 the signals as normal. If the peer device determines 212, it is not the destination for the received signal, it may further determine 215 whether the received signal is for cooperative diversity transmission. If not, the peer device may ignore 220 the packet. If the received signal is determined 215 to be for cooperative diversity transmission, then the peer device may encode and/or transmit 225 the signal.

In one embodiment, the cooperative diversity transmission should be performed substantially at the same time that other peer devices may retransmit the signal and/or so the signals arrive at the destination substantially at the same time. Accordingly, some synchronization between peer devices may be performed and/or in networks having scheduled transmissions, the peer devices may retransmit the received signal at the next transmit opportunity (e.g., TXOP) although the inventive embodiments are not limited in this respect. Various implementation specific alternatives could be used for synchronizing cooperative diversity transmissions and the inventive embodiments are not intended to be limited to any particular method for synchronization. Cooperating peer devices may encode transmitted signals by many methods. When no channel knowledge is available, they may use open-loop diversity methods such as space-time diversity codes (e.g. Alamouti code). When full channel knowledge is available, they may use beamforming or singular value decomposition of channel matrix. When partial channel knowledge is available, they may use phase information to co-phase signal. In general, any codes used for multiple antenna systems such as MIMO may be used here.

As mentioned previously, the signal transmitted from the originating device may include an indicator in a PHY packet so peer devices may quickly determine that the packet should be cooperatively transmitted. However, the embodiments herein are not limited to any particular encoding or signaling technique and, for example, such indicator could be implemented in the data-link layer addressing or processing if desired. For that matter, there is no specific requirement that the peer devices even detect a specific signal designating cooperative transmission as the peer devices may simply retransmit, e.g., in the next transmission opportunity, any signal that is not addressed to the receiving peer device.

In inventive embodiments, retransmission does not require any power normalization between transmissions of the various network devices; however, some synchronization between peer devices is beneficial to ensure proper coherent gain. For example, in practice, cooperative transmission may suffer some loss from imperfect synchronization. Accordingly, in one embodiment using OFDM, the cyclic prefix may provide a buffer zone allowing coarse synchronization within the duration of the cyclic prefix. Synchronization of cooperative peer devices may be performed periodically, for example during network maintenance, and will remain valid longer in a slowly varying channel.

In order to achieve full diversity gain of a comparative MIMO system possible implementation specific synchronization options may include:

Time Synchronization

In the inventive embodiments, cooperator packets should arrive at destination with no relative delay. To that end, synchronization of cooperative transmissions in time may utilize, for example, OFDM modulation that has a guard period built in against delay spread.

Frequency Synchronization

To obtain frequency synchronization for cooperative transmissions by peer devices, the devices may estimate carrier frequency offsets during initial packet sharing for cooperation, use infrastructure beacons as a common clock, and/or local oscillators of cooperators should run at same frequency as destination device.

Phase Synchronization

Cooperators should be co-phased with respect to the destination devices. Consequently, extra signaling could be used similar to calibration methods for closed-loop MIMO.

Various synchronization techniques for fixed and/or mobile systems may be used and the foregoing is a non-limiting description of some factors that might be considered. Advantages of the inventive embodiments include transmissions using spatial diversity to help reduce fading, shadowing and path-loss without increasing transmit power or frequency bandwidth per node. Further, the inventive embodiments offer a flexible approach which may be complementary to existing mesh and/or MIMO systems.

Additionally, various aspects of the inventive embodiments may be used to support variable quality of service (QoS) on demand. In general, the inventive embodiments can increase range and throughput as well as decrease latency, not just increase range. For example, if a source-destination pair requires the highest possible throughput, all of their neighbors can cooperate to increase the data rate, throughput, range and/or decrease latency etc. This can be done in a highly adaptive, flexible manner. One important potential application might be for example, a response to critical events, for example sensor networks that trigger alarms may need to send out a high rate data impulse when they detect a threat.

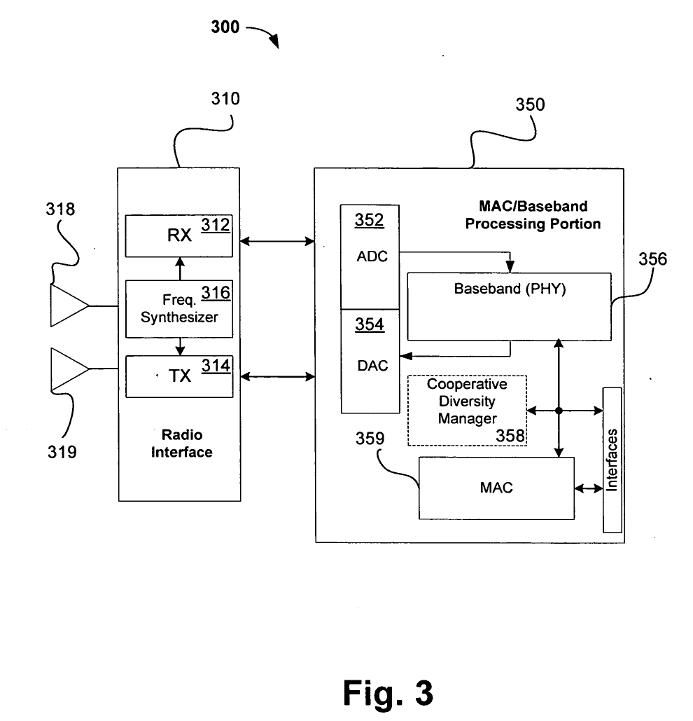

Referring to FIG. 3, an apparatus 300 for use in a wireless network may include a processing circuit 350 including logic (e.g., circuitry, processor(s) and software, or combination thereof) to encode, detect and/or retransmit distributed communications as described in one or more of the processes above. In certain embodiments, apparatus 300 may generally include a radio frequency (RF) interface 310 and a baseband and medium access controller (MAC) processor portion 350.

In one example embodiment, RF interface 310 may be any component or combination of components adapted to send and receive modulated signals (e.g., OFDM) although the inventive embodiments are not limited to any particular modulation scheme. RF interface 310 may include, for example, a receiver 312, a transmitter 314 and a frequency synthesizer 316. Interface 310 may also include bias controls, a crystal oscillator and/or one or more antennas 318, 319 if desired. Furthermore, RF interface 310 may alternatively or additionally use external voltage-controlled oscillators (VCOs), surface acoustic wave filters, intermediate frequency (IF) filters and/or radio frequency (RF) filters as desired. Various RF interface designs and their operation are known in the art and the description for configuration thereof is therefore omitted.

In some embodiments interface 310 may be configured to provide OTA link access which is compatible with one or more of the IEEE standards for WPANs, WLANs, WMANs or WWANs, although the embodiments are not limited in this respect.

Processing portion 350 may communicate/cooperate with RF interface 310 to process receive/transmit signals and may include, by way of example only, an analog-to-digital converter 352 for down converting received signals, a digital-to-analog converter 354 for up converting signals for transmission, and a baseband processor 356 for physical (PHY) link layer processing of respective receive/transmit signals. Processing portion 350 may also include or be comprised of a processing circuit 359 for medium access control (MAC)/data link layer processing.

Processing portion may include a cooperative diversity management feature 358 which may function to encode, decode, process and/or retransmit signals for cooperative diversity transmission as described previously. Alternatively or in addition, PHY circuit 356 and/or MAC circuit 359 may share processing for certain of these functions or independently perform these processes as desired. MAC, PHY and cooperative diversity processing may also be integrated into a single circuit if desired.

Apparatus 300 may be, for example, a wireless base station or AP, wireless router and/or network adaptor for electronic devices. Accordingly, the previously described functions and/or specific configurations of apparatus 300 could be included or omitted as suitably desired.

Embodiments of apparatus 300 may be implemented using single input single output (SISO) architectures. However, as shown in FIG. 3, certain preferred implementations may use multiple input multiple output (MIMO) architectures having multiple antennas (e.g., 318, 319) for transmission and/or reception. Further, embodiments of the invention may utilize multi-carrier code division multiplexing (MC-CDMA) multi-carrier direct sequence code division multiplexing (MC-DS-CDMA) for OTA link access or any other existing or future arising modulation or multiplexing scheme compatible with the features of the inventive embodiments.

The components and features of apparatus 300 may be implemented using any combination of discrete circuitry, application specific integrated circuits (ASICs), logic gates and/or single chip architectures. Further, the features of apparatus 300 may be implemented using microcontrollers, programmable logic arrays and/or microprocessors or any combination of the foregoing where suitably appropriate (collectively or individually referred to as “logic”).

It should be appreciated that the example apparatus 300 represents only one functionally descriptive example of many potential implementations. Accordingly, division, omission or inclusion of block functions depicted in the accompanying figures does not infer that the hardware components, circuits, software and/or elements for implementing these functions would be necessarily be divided, omitted, or included in embodiments of the present invention.

Unless contrary to physical possibility, the inventors envision the methods described herein: (i) may be performed in any sequence and/or in any combination; and (ii) the components of respective embodiments may be combined in any manner.

Although there have been described example embodiments of this novel invention, many variations and modifications are possible without departing from the scope of the invention. Accordingly the inventive embodiments are not limited by the specific disclosure above, but rather should be limited only by the scope of the appended claims and their legal equivalents.

The invention claimed is:

1. A method for communicating in a wireless network, the method comprising:
receiving a signal at a first device from a second device;
determining that the signal is for cooperative diversity transmission; and
re-transmitting the signal.

2. The method of claim 1 wherein determining that the signal is for cooperative diversity transmission includes observing an indicator in a physical (PHY) layer packet.

3. The method of claim 1 wherein re-transmitting is substantially synchronized with transmitting of substantially similar signals by one or more peer network devices.

4. The method of claim 1 wherein there is no power normalization between transmissions of the first device, the second device or the one or more peer devices.

5. The method of claim 1 wherein the wireless network comprises a wireless personal area network (WPAN)

6. The method of claim 1 wherein the wireless network comprises a wireless local area network (WLAN)

7. The method of claim 1 wherein the wireless network comprises a wireless metropolitan area network (WMAN).

8. The method of claim 1 wherein re-transmitting is performed using multi-carrier modulation.

9. A method of communicating in a wireless network, the method comprising:
determining that a destination device is outside of a communication range of an originating device; and
generating a transmission for the destination device including signaling to cause two or more peer devices in the wireless network to retransmit the transmission so that it arrives at the destination device substantially at the same time.

10. The method of claim 9 wherein the signaling includes an indicator in a physical (PHY) layer packet that the transmission is for cooperative diversity transmission by the peer devices.

11. The method of claim 9 further comprising broadcasting the transmission using orthogonal frequency division multiplexing (OFDM) modulation.

12. The method of claim 9 wherein determining that the destination device is outside of the communication range comprises failing to receive a response from the destination device in response to a request to send (RTS) message sent by the originating device.

13. A wireless device comprising:
a processing circuit including logic to identify that a received signal is for cooperative diversity transmission and retransmit the received signal at a next transmit opportunity.

14. The wireless device of claim 13 wherein the logic comprises a physical (PHY) layer circuit to detect an indicator in a PHY packet indicating the received signal is for cooperative diversity transmission.

15. The wireless device of claim 13 further comprising a radio frequency (RF) interface in communication with the processing circuit to broadcast and receive signals.

16. The wireless device of claim 15 wherein the RF interface includes at least two antennas for at least one of multiple input or multiple output communication.

17. The wireless device of claim 13 wherein the processing circuit further includes logic to enable the wireless device to serve as an ad-hoc node in a wireless mesh network.

18. The wireless device of claim 13 wherein the received signal is a PHY packet modulated using orthogonal frequency division multiplexing (OFDM).

19. The wireless device of claim 13 wherein the processing circuit further includes logic to encode transmissions for subsequent cooperative diversity transmission by peer network devices.

20. A wireless system comprising:
a processing circuit including logic to resend a received signal substantially in synchronization with one or more peer network devices;
a radio frequency (RF) interface communicatively coupled to the processing circuit; and
at least two antennas coupled to the RF interface for at least one of multiple input or multiple output communication.

21. The wireless system of claim 20 wherein the processing circuit further includes logic to distinguish the received signal as being intended for cooperative diversity transmission.

22. The wireless system of claim 20 wherein the processing circuit further includes logic to generate a transmission having an indicator to cause the one or more peer devices to retransmit the transmission substantially simultaneously.

23. The wireless system of claim 22 wherein the indicator is present in a physical (PHY) layer packet.

24. The wireless system of claim 20 wherein the received signal is resent using orthogonal frequency division multiplexing (OFDM) modulation.
